(19) United States
(12) Patent Application Publication
(10) Pub. No.: US 2013/0299429 A1
(43) Pub. Date: Nov. 14, 2013

(54) WASTEWATER TREATMENT PROCESS

(71) Applicants: Noel Connaughton, County Roscommon (IE); Dermot Nally, County Westmeath (IE); Jamie Wood, County Sligo (IE)

(72) Inventors: Noel Connaughton, County Roscommon (IE); Dermot Nally, County Westmeath (IE); Jamie Wood, County Sligo (IE)

(73) Assignee: PHOSBOX TECHNOLOGIES LIMITED, County Roscommon (IE)

(21) Appl. No.: 13/988,061

(22) PCT Filed: Nov. 21, 2011
(86) PCT No.: PCT/EP11/70605

§ 371 Date: Jul. 29, 2013

(30) Foreign Application Priority Data
Nov. 19, 2010 (EP) 10191952.0

(51) Int. Cl. C02F 1/28

(52) U.S. Cl. CPC C02F 1/281
USPC 210/663; 210/660; 264/43

(57) ABSTRACT

A method for processing fines materials generated as a by-product from the screening and washing of sand and gravel includes the steps of drying, pelletising and firing the fines materials to produce a ceramic material in the form of porous pellets which have enhanced properties for the removal of phosphorus and pathogens from wastewater.

### FIELD OF THE INVENTION

The present invention relates to a method of treating water to remove phosphorus and other contaminants using a waste by-product produced during the processing of sand and gravel. More particularly, the invention relates to a method of processing this waste by-product to improve its physical and chemical characteristics and a method of incorporating the product into a simple and easy to use system for the treatment of water and wastewater.

### BACKGROUND

Phosphorus, together with nitrogen, is often the limiting nutrient for primary production in fresh water systems such as lakes, rivers and streams and in some instances, in sea estuaries. While phosphorus is not directly toxic to aquatic organisms, phosphorus can cause the excessive growth of algal blooms in water. These algal blooms can be unsightly, interfere with the beneficial use of the water and when the algae decay, this can lead to oxygen depletion in the water which can cause fish kills. In addition, some algae are toxic. Ideally, phosphorus concentrations in natural waters should be below about 0.03 mg/l to avoid problems with algal blooms.

Untreated wastewater usually contains, among other contaminants, nutrients, mainly nitrogen and phosphorus (P). It has been estimated that urban residents discharge about 2-3 g P per capita per day in wastewater (including contributions of P in household detergents). The concentration of phosphorus in the untreated wastewater at the inlet to a wastewater treatment plant is highly variable and depends on the quantity of water used by the community and the amount of additional rainwater and groundwater infiltration into the sewerage network. Typical phosphorus concentrations range from about 3-12 mg/l. At conventional wastewater treatment plants, the main focus of attention to date has been the removal of organic matter and suspended solids and if no specific measures are taken to remove phosphorus, the phosphorus concentration in the wastewater is only marginally reduced, reflecting the phosphorus requirements of the biomass generated in the biological treatment stage. Furthermore, some wastewater treatment plants incorporate regional sludge treatment facilities to treat imported sludge to the facility and this may result in an increased phosphorus load to the wastewater treatment plant.

An increasing number of wastewater treatment plants are legally required to incorporate phosphorus removal technologies and strict limits are being set on the maximum phosphorus concentration in the treated effluent, varying from as low as 0.1-2 mg/l. In many instances, the conventional technologies currently available will not be able to achieve these low limits, additional processes such as tertiary filtration may be required and a very significant quantity of additional sludge is generated which increases the cost of treatment very significantly.

A number of methodologies have traditionally been used to remove phosphorus from municipal wastewater treatment plants. These include the following:

| Conventional | |
|---|---|
| Phosphorus | |
| Removal Systems | Disadvantages |
| Metal salt | Bunded storage facilities required for acidic chemicals |
| (aluminium | Emergency eye-wash shower required |
| or iron) | Accurate chemical dosing system required |
| addition | Accurate flow monitoring system required |
| | Can interfere with or inhibit the biological processes |
| | used in conventional treatment systems to remove |
| | organic matter |
| | Typically lowers the pH and may require addition of |
| | alkali to neutralize the pH |
| | Significantly increases the quantity of sludge gener- |
| | ated which in turn increases both the capital and |
| | operating costs |
| Lime | Costly storage facilities required |
| | Accurate chemical dosing system required |
| | Accurate flow monitoring system required |
| | Increases the pH and requires addition of acid to |
| | neutralise the pH |
| | Very significantly increases the quantity of sludge |
| | generated which in turn increases both the capital and |
| | operating costs |
| Biological | Requires numerous inter-dependent processes that |
| Phosphorus | must be coordinated |
| Removal | Requires high degree of control on influent character- |
| | istics |
| | Large footprint compared to chemical systems |
| | Sludge contains high concentrations of phosphorus |
| | which may be released back into the main flow follow- |
| | ing dewatering of digested sludge |
| | Phosphorus ultimately removed from a side-stream |
| | using chemicals |

Single households traditionally have had to rely upon low-cost small-scale wastewater treatment systems such as septic tanks. Sorption of phosphorus to the percolation area substratum within these systems has been recognised as one of the most important P removal mechanisms in one-off housing systems (Richardson, C. J. (1985), Mechanisms controlling phosphorus retention capacity in freshwater wetlands. Science, 228, 1422-1427).

Traditionally, locally available materials such as sand and soils have been used for P-removal. In many cases, these substrates have been used without any knowledge of the P-retaining capacities, even though some recent studies have aimed at investigating the P-sorption capacity of different materials (C. A. Arias, M. del Bubba and H. Brix, 2001, Phosphorus Removal by Sands for Use as Media in Subsurface Flow Constructed Reed Beds. Department of Plant Ecology, University of Aarhus, Nordlandsvej 68, dk-8240 Risskov, Denmark).

In recent years, research has been directed to a selection of substrates for phosphorus removal due to the fact that the P-sorbing capacity of the substratum is a crucial parameter for P-removal in many systems (Drizo, A., Comeau, Y., Forget, C. and Chapuis, R. P., 2002, Phosphorus saturation potential—A parameter for estimating the longevity of constructed wetlands systems. Environ. Sci. Tech., 36(21), 4642-4648).

Since the sorption, e.g. adsorption and/or precipitation mechanisms is a finite process, it is an important factor to consider when selecting substrates for potential use as a substratum in a P filter for use in a constructed wetland system or in other small scale wastewater treatment systems. Other reasons for searching for alternative substrates are that local substrates are not always available at a reasonable cost (Geohring, L. D., T. S. Steenhuis, N. Corrigan, M. Ries, M. Cohen, K. Cabral, R. Stas, R. De, J. H. Peverly., 1995, Specialized substrates for phosphorus removal with constructed wetlands. In: Proceedings, Versatility of Wetlands in the Agricultural Landscape Conference. Tampa Fla. September 1995; Sakadevan, K. and Bavor, H. J., 1998, Phosphate Adsorption Characteristics of Soils, Slags and Zeolite to be Used As Substrates in Constructed Wetland Systems. Water Research Vol. 32, No. 2: 393-399). This research has been extended to cover a wide variety of potential substrates which have potential to remove phosphorus from wastewater in both municipal and small scale systems and which also have application in phosphorus removal from industrial waste streams. Some of the reported materials include minerals and rocks, soils, marine sediments, industrial by-products from the steel and mining industries and man-made products (Johansson, L. & Gustafsson, J P., Phosphate removal using blast furnace slags and opoka-mechanisms, Water Res. 34 (2000) 259-265). More recently, significant moves have been made towards developing new P removal technology which reduces the generation of sludge, selectively adsorb/absorb or precipitate P out of a wastewater stream and which do not require large infrastructure or capital investment to produce, use and install. In particular, investigation has focused on the use of clay, bauxite, fly ash, red mud and volcanic ash.

To establish a sustainable phosphorus removal system that is suitable in dealing with real wastewater at a full-scale treatment plant, the process must be able to demonstrate numerous attributes and the absence of one or more of these attributes will render the system non-viable on technical, environmental and/or economic grounds. The ideal phosphorus removal media should comply with the following criteria:
1. The process must be capable of treating real wastewater rather than small synthetic samples in a laboratory.
2. The process must be capable of reducing typical phosphorus concentrations in wastewater to the levels required in the licence conditions now being imposed internationally (e.g. greater than 80% removal and with a residual P concentration typically in the region of 0.5-2 mg/l, depending on the sensitivity of the receiving water).
3. The media must not contain hazardous materials in such concentrations that some of these materials are released into the treated wastewater above the safe/allowable limits.
4. The media must be sufficiently porous and permeable to allow wastewater to pass through at a reasonable rate without getting clogged.
5. The media must be sufficiently robust (e.g. hard and free of excessive dust) that the media will not disintegrate over its expected useful life.
6. The media must have sufficient phosphorus sorption capacity that the media can continue to perform at the required performance level for many years. This allows the use of reasonably small quantities of material and ensures that the process is cost effective.
7. The media must not generate large volumes of additional waste sludges or chemical regeneration streams that negate the advantage of using such systems in the first instance. It should be noted that the cost of treating and disposing of the additional chemical sludge generated by conventional chemical precipitation of phosphorus from wastewater accounts for a very large portion of the overall cost and can exceed the cost of the treatment chemicals by a factor of five.
8. At the end of the useful life of the media, it must be able to release the trapped phosphorus so that the phosphorus can be effectively recovered for reuse in agriculture or in an industrial process.
9. The system must be able to cope with the varying conditions encountered at a real wastewater treatment plant such as variations in flowrate and chemical characteristics without the need for very sophisticated and expensive control systems.
10. The overall capital and operating costs of the system must be competitive with existing technologies so that municipalities and the public can afford to use these new technologies.

The present invention is directed to addressing many of these problems.

### SUMMARY OF THE INVENTION

According to the invention there is provided a method for manufacturing wastewater treatment pellets comprising the steps of pelletising mineral fines having a particle size of less than 0.063 mm and firing the pellets for forming porous wastewater treatment pellets.

In one embodiment of the invention there is provided a method for the processing of fines materials generated as a by-product from the screening and washing of sand and gravel comprising the steps of drying, pelletising and firing the fines material to produce a ceramic material in the form of pellets with enhanced phosphorus removal properties.

Advantageously the ceramic material pellets have enhanced hydraulic conductivity and reduced bulk density compared to the fines materials.

In one embodiment the method includes the step of drying the mineral fines to a moisture content in the range of 10% to 20% by weight. Preferably the mineral fines are dried to a moisture content in the range of 15% to 17%.

In a further embodiment, the method includes forming the pellets by means of a rolling process.

In another embodiment, the pellets have a diameter of 0.5 mm to 30 mm, and more preferably a diameter of 1 to 15 mm.

In another embodiment, the ceramic material pellets have the following physical and chemical properties

| Parameter | Typical Value | |
|---|---|---|
| Average Particle Size | 0.5-30 | mm |
| Loose Bulk Density | 700-1200 | Mg/m³ |
| Hydraulic Conductivity | 3-5 × 10⁻² | m/s |
| Water Absorption | 30-50% | by weight |
| SiO₂ | 20-60% | by weight |
| CaO | 25-75% | by weight |
| Al₂O₃ | 1-20% | by weight |
| Fe₂O₃ | 1-20% | by weight |

In another embodiment, the firing step takes place at a temperature of between 600° C.-1200° C., preferably between 1000° C. and 1200° C., more preferably between 1050° C. and 1150° C.

In another embodiment, the energy used for the drying and/or firing of the pellets is from a renewable energy source such as biogas.

In another embodiment, the pellets remove phosphorus from water to an order of approximately 150-200 g P/kg of ceramic material.

In another embodiment, the pellets are solid and retain their shape and durability when submerged for long periods in water.

In another aspect, the invention provides a wastewater treatment process for removing phosphorus from wastewater, including the step of bringing the wastewater into contact with the wastewater treatment pellets.

In another embodiment, the process includes passing the wastewater through a container having a wastewater inlet and a wastewater outlet and a plurality of wastewater treatment pellets mounted between the wastewater inlet and the wastewater outlet.

In another embodiment, the process includes holding the wastewater treatment pellets in suspension in the wastewater.

In a further embodiment, the process includes the step of controlling the flow of the wastewater to maintain the wastewater in contact with the wastewater treatment pellets for a desired time period.

In another embodiment, the wastewater treatment pellets are mounted in one or more cartridges which are demountably secured within the container.

In another embodiment, the cartridge has a water impermeable wall with a water inlet and a water outlet to direct wastewater flow through the wastewater treatment pellets within the cartridge.

In another embodiment, the cartridge has a perforated side wall to all through-passage of the wastewater.

In another embodiment, a portion of the treated wastewater is recycled from the wastewater outlet of the container back to the wastewater inlet of the container.

In another embodiment, the process includes after treatment of the wastewater by the wastewater treatment pellets, the step of passing the treated wastewater through a soil polishing filter, or other passive medium to reduce the pH of the treated wastewater to less than 9.

In another embodiment, the process includes after-treatment of the wastewater by the wastewater treatment pellets. The step of reacting the treated wastewater with carbon dioxide to reduce the pH to less than 9.

In another embodiment, the process includes after-treatment of the wastewater with the wastewater treatment pellets, the step of dosing the treated wastewater with an acid to reduce the pH to less than 9.

In another embodiment, the process includes the step of recovering the phosphorus captured by the wastewater treatment pellets during the process.

In another aspect, the invention provides a method of removing phosphorus from water comprising contacting the water to be treated with the pellets produced according to the method described herein to remove phosphorus from the water to the order of approximately 150-200 g P/kg of pellets.

In another embodiment, the pellets are placed in a container and the water to be treated flows through the pellets in the container in an upflow, downflow and/or horizontal flow mode.

In another embodiment, the pellets are placed in removable cartridges that can be readily and quickly removed from the container holding the wastewater without having to empty the wastewater from its container. The cartridges may have solid walls with the wastewater either pumped or flowing by gravity through the media. Alternatively, the cartridges may have perforated walls, thereby facilitating contact between the wastewater and the media.

In another embodiment, a portion of the treated wastewater is recycled back through or around the cartridges or back into the container holding the wastewater to increase the contact time between the wastewater and the media.

In another embodiment, the pellets are held in suspension by the flow of liquid in the container or by a mixing process to allow sufficient contact time between the ceramic material pellets and the water to remove the phosphorus from the water.

In another embodiment, the phosphorus is retained by the pellets and does not re-dissolve back into the water.

In another embodiment, the high pH of the treated wastewater using the method of this invention is reduced by passing the treated wastewater through a soil polishing filter or other passive medium to reduce the pH to less than 9 to allow the wastewater to be discharged directly to a surface water body such as a stream, river, lake or estuary.

In another embodiment, the high pH of the treated wastewater using the method of this invention is reduced by reaction with carbon dioxide to reduce the pH to less than 9 to allow the wastewater to be discharged directly to a surface water body such as a stream, river, lake or estuary.

In another embodiment, the high pH of the treated wastewater using the method of this invention is reduced by dosing with an acid to reduce the pH to less than 9 to allow the wastewater to be discharged directly to a surface water body such as a stream, river, lake or estuary

In another aspect, the invention provides a method for recycling phosphorus contained within the pellets produced according to the method of the invention described herein, wherein the retained phosphorus or has low phosphorus concentrations is recovered as a liquid by flushing with water that does not contain phosphorus or by other means or as a solid fertilizer, soil conditioner or source of recovered or recycled phosphorus for commercial or industrial use. The used pellets may be crushed for use as a solid fertiliser.

In a further aspect, the invention provides a method for the combined removal of one or more of phosphorus, suspended solids, suspended organic matter, ammonia and pathogens from water comprising the use of the pellets produced by the method described herein.

In a still further aspect, the invention provides a method for the neutralisation of acidic wastes, such as acid mine drainage, comprising the use of the pellets produced by the method described herein.

In another aspect, the invention provides a method for pH correction in water and wastewater treatment comprising the use of the pellets produced by the method of the invention described herein.

### BRIEF DESCRIPTION OF THE DRAWINGS

The present invention will now be described with respect to the following non-limiting examples and figures, in which:

FIG. 1: Equilibrium Phosphorus Concentration vs. Mass of Media Used

FIG. 2: Mass of Phosphorus Retained by Media vs. Mass of Media Used

FIG. 3: Effect of Mass of Media Used on Phosphorus Removal Rate

FIG. 4: Effect of Media Particle Size on Phosphorus Removal and Sorption

FIG. 5: Effectiveness of Phosphorus Removal using Raw Material and Processed Media

FIG. 6: Concentration of Phosphorus after 8 days contact with Unprocessed Aggregate Fines (Initial Phosphorus Conc.=1895 mg/l)

FIG. 7: Percentage Phosphorus Removal using Raw Fines Material from various Geological Formations around Ireland

FIG. 8: Concentration of Phosphorus after contact and settlement with various quantities of media in various formats compared to the use of Lime

FIG. 9: Percentage Phosphorus Removal versus Cumulative Flow for Influent Concentrations from 1000 mg/l to 38625 mg/l

FIG. 10: Percentage Phosphorus Removal versus Cumulative Flow for Influent Concentrations from 5 mg/l to 1000 mg/l

FIG. 11: Cumulative Phosphorus Removal per kg of Media versus Cumulative Flow for Influent P Concentrations from 1000 mg/l to 38625 mg/l

FIG. 12: Cumulative Phosphorus Removal per kg of Media versus Cumulative Flow for Concentrations from 5 mg/l to 1000 mg/l

FIG. 13: Phosphorus removal over a 30 month long trial using pellets fired at different temperatures

FIG. 14: Concentration of Phosphorus after contact with media processed at 1200° C. and with varying contact times

FIG. 15: Concentration of Phosphorus after contact with media processed at 1100° C. and with varying contact times

FIG. 16: Percentage of Phosphorus removal after various contact times with media processed at 1150° C.

### DETAILED DESCRIPTION OF THE INVENTION

In this specification, the term “raw material” will be understood to relate to the fines material generated as a by-product from the screening and washing of sand and gravel. This material typically has individual particle sizes of less than 63 microns, reflecting the very fine material that must be removed from natural sands and gravels to make them suitable for the construction industry.

In this specification, the term “processed material” refers to the processed raw material having undergone the drying, pelletising and firing the fines material to produce a ceramic material in the form of pellets. The “processed material” may also be referred to as “media”/“processed media” or “pellets”/“processed pellets”.

In this specification, the term “water” covers water with phosphorus or other undesirable contaminants, including wastewater.

One of the objectives of the present invention is to provide a processed material that is free from the disadvantages of conventional techniques for phosphorus removal and which can be effectively used in a simple process at both large and small scale facilities to remove phosphorus from a variety of wastewater streams.

Advantageously, the present invention proposes to accomplish these aims by utilising a material which is currently a waste by-product requiring disposal.

Specifically, the invention involves drying, pelletising and firing waste mineral fines to produce a media or processed material which has the characteristics of high durability, excellent hydraulic conductivity and porosity and most importantly, an ability to selectively remove a very high percentage of phosphorus from wastewater streams, across a broad range of pH and influent phosphorus concentrations and with an ability to sorb very high quantities of phosphorus relative to its mass and volume compared to other media used for this purpose.

Advantageously, the processed material containing the sorbed phosphorus is useful as a raw material in commercial or industrial processes as an alternative to the use of mined phosphorus and also has potential for use directly as a phosphorus fertilizer. Thus, the phosphorus may be recycled.

Tables 1 and 2 below set out some of the significant general characteristics of the raw and processed material respectively.

TABLE 1
Characteristics of Raw Material

| Parameter | Dimensions | Typical Value |
|---|---|---|
| Particle Size | Mm | 100% less |
| | | than 0.063 mm |
| Bulk Density | Mg/m³ | 1400-1600 |
| Hydraulic Conductivity | m/s | 10⁻⁶-10⁻⁸ |
| Hydraulic Conductivity | m/day | 0.000864-0.0864 |
| Calcite | % by weight | 47-50 |
| Quartz | % by weight | 26-30 |
| Illite/Muscovite | % by weight | 8-11 |
| Plagioclase | % by weight | 4-5 |
| Kaolinite | % by weight | 3-5 |
| Dolomite | % by weight | 3-4 |
| K-Feldspar | % by weight | 1-2 |
| Chlorite | % by weight | 1 |

Note:
The characteristics of the waste aggregate fines are likely to vary considerably depending on the underlying geological formations at different aggregate processing facilities. Table 1 relates to one specific sample tested.

TABLE 2
Characteristics of Processed Material from Table 1

| Parameter | Dimensions | Typical Value |
|---|---|---|
| Particle Size | mm | 0.5-30 |
| | | (1-15) |
| Flakiness Index | % | 0 |
| Loose Bulk Density | Mg/m³ | 800 |
| Compacted Bulk Density | Mg/m³ | 860 |
| Mohs Hardness Value | Mohs Scale (0-10) | 3 |
| Hydraulic Conductivity | m/s | 3.5 × 10⁻² |
| Hydraulic Conductivity | (m/day) | 3024 |
| Resistance to | Los Angeles | 67 |
| Fragmentation | Coefficient (%) | |
| Apparent Particle | Mg/m³ | 2.45 |
| Density | | |
| Particle Density on an | Mg/m³ | 1.35 |
| Oven-Dried Basis | | |
| Particle Density on a | Mg/m³ | 1.80 |
| Saturated and Surface- | | |
| Dried Basis | | |
| Water Absorption | % by weight | 33.30 |
| SiO₂ | % by weight | 46.21 |
| CaO | % by weight | 30.77 |
| Al₂O₃ | % by weight | 6.37 |
| Fe₂O₃ | % by weight | 3.56 |
| MgO | % by weight | 1.73 |
| K₂O | % by weight | 1.64 |
| Na₂O | % by weight | 0.38 |
| TiO₂ | % by weight | 0.34 |
| MnO | % by weight | 0.10 |
| P₂O₅ | % by weight | 0.05 |

| | |
|---|---|
| X-Ray Defraction | The processed material is a mixture of silicate |
| (XRF) Analysis | minerals (gehlenite-calcium-sodium- |
| | magnesium-aluminium-iron-alumino-silicate), |
| | quartz, larnite, Wollastonite, |
| | Cristobalite and rutile. |

It is clear from the characteristics in Tables 1 and 2 above that the processing of the raw material in accordance with this invention transforms an essentially impermeable fine grained waste material into a round hard pellet with greatly enhanced hydraulic conductivity and reduced bulk density.

Furthermore, the processing of the raw material in accordance with this invention transforms the chemical nature of the raw material, and in particular transforms the CaCO₃ component into CaO, with the release of CO₂. It is already well known that CaO, MgO, Al₂O₃ and Fe₂O₃ are effective in removing phosphorus from water and wastewater. However, a major disadvantage of the conventional use of these chemicals is that they generate a large quantity of sludge and it is difficult to continually and consistently remove phosphorus to the low concentrations now being required internationally.

Based on the amount of Ca, Mg, Al and Fe in the processed material as presented in Table 2 above, it would be expected that under optimum conditions, the combined phosphorus binding capacity would be in the region of 150 to 200 g P/kg of media, depending on the availability of reaction sites between the media and the wastewater, adequate contact time and the precise nature of the reaction products formed.

We have found that by placing the processed material in a container and allowing water or wastewater to simply flow through or around the processed material, the vast bulk of any dissolved phosphorus in the water or wastewater is retained by the processed material. This has the great advantage of not requiring the supply, storage and preparation and dosing of chemicals such as lime or metal salts and an even greater advantage is that no sludge is generated, thereby eliminating the need for sludge storage, treatment and disposal facilities and their associated additional costs.

The processed material is ideally in the form of porous pellets, ranging in size from about 0.5 mm to over 30 mm in diameter, but more preferably in the range of 1-15 mm in diameter, depending on the precise requirements in relation to both phosphorus and suspended solids removal. Where larger pellets are generated in the manufacturing process, they can be crushed to the required size if necessary.

The processed material possesses interlinked cavities providing a large surface area, both externally and internally. The method of processing results in the formation of ceramic matrices that gives the material strength and durability but enables the material to retain its porous nature. The form of the material ensures good hydraulic conductivity whilst the porous nature of the material allows contact to be made between the processed material and the liquid in the internal surfaces. The porosity of the processed material is an inherent property of the invention related to the method of preparation and process temperature and retention time, and occurs without the need for other additives, further processing or crushing.

The processed material is ideally made by the following method. Waste fines and silt resulting from the washing and further processing of sand and aggregate or similar material is removed from settlement lagoons, centrifuges, presses or any other dewatering, dust control or other filtering mechanism which exists downstream from aggregate processing, sorting or washing plants. This raw material is dried (where necessary) and formed into pellets. Preferably, the pellets are formed by a rolling process rather than an extrusion process.

The pellets are then fired to a temperature of between 600 and 1200° C. The optimum temperature for this firing process is dependent on individual characteristics of the fines material and can vary, depending on the source of the raw material. The processing temperature for each raw material is selected so that it is sufficient for solidification and hardening of the pellets, but is below that at which the outer surface of the pellets becomes dense and glassy, as this will form a barrier against free flow of liquid from the surroundings into the pellet and would typically necessitate the subsequent crushing of the material. In the majority of cases, the ideal temperature for processing occurs between 950° C. and 1200° C. and more preferably between 1050° C. and 1150° C. The processed material has been manufactured in accordance with this invention using batch and continuous processes and using electricity, oil and gas as the heat source. All methods of production resulted in enhanced phosphorus removal compared to the raw material.

Other matrix forming processes which could be adopted to process the raw material, such as lime addition, the addition of fines from the crushing of stone, processing with the addition of a binding agent or any other solidification process, is deemed within the spirit of this invention and may also be utilised to produce a solid pellet from the raw material, which may have similar or the same characteristics as that outlined in this patent specification.

Once produced, the pellets can be utilised to remove phosphorus or other elements from a wastewater stream.

The invention as detailed above is an extremely versatile product and can be used in many ways in water and wastewater treatment including:
use as a filter medium in a passive water or wastewater filter,
as a filter material in a pumped flow through system (with or without recycle),
as a bedding material in constructed wetland systems (either throughout the entire bed or in sections),
as a substrate in a percolating trench,
as a substrate in natural systems with elevated phosphorus levels,
as a medium in fluidised bed systems or as a powder or fine grained medium which is mechanically or hydraulically mixed with the water or wastewater to be treated and subsequently separated.

The invention works by promoting the sorption and/or precipitation of phosphorus as a solid from the liquid waste stream. This phosphorus rich solid material is weakly bonded to the media, and this phosphorus can be released back slowly to water, thereby making it useful as a fertilizer. Any solid material not attached to the media settles quickly (as demonstrated in laboratory tests) and shows very little tendency to re-dissolve into the wastewater stream.

The reaction commences immediately on contact between the phosphorus in the water or wastewater stream and the processed material, but the efficiency of this process depends on the starting phosphorus concentration, the contact time and the mass of phosphorus already retained by the processed material.

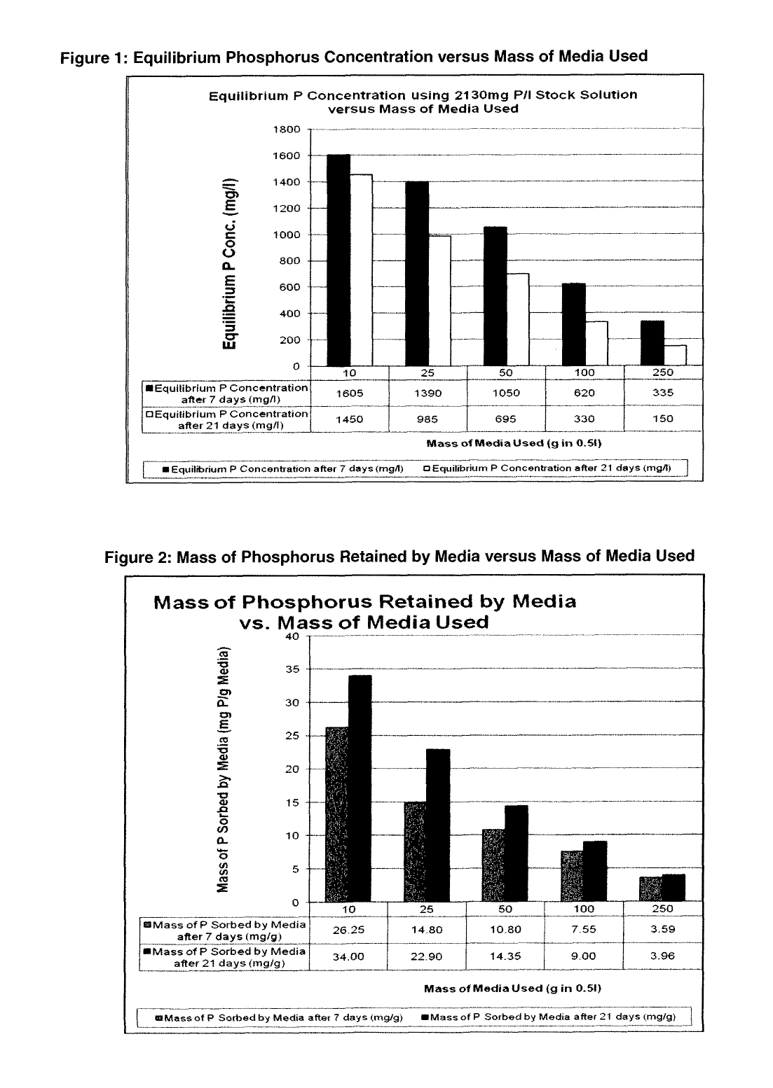

In general, the greater the contact time and the greater the quantity of processed material used, the greater the quantity of phosphorus removed as indicated in FIGS. 1 and 2.

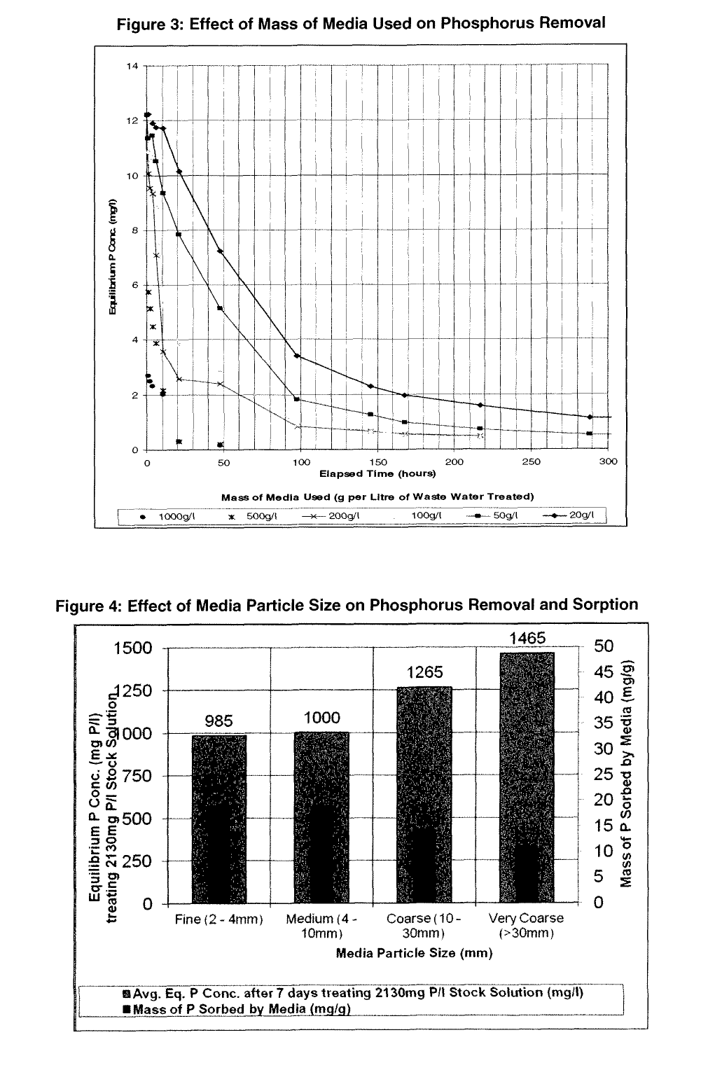

The mass of processed material used relative to the quantity of water or wastewater treated has an important bearing on the efficiency of phosphorus removal as indicated in FIG. 3. In particular, it is clear from FIG. 3 that the greater the quantity of processed material in contact with the wastewater to be treated, then the reaction rate is greatly increased, with virtually all of the phosphorus removed in a period of 20 hours compared to over 300 hours when a smaller mass of processed material is used.

The processed material particle size also has a bearing on the efficiency of the phosphorus removal process as indicated in FIG. 4. In general, the smaller the processed material particle size, the greater the efficiency of phosphorus removal and the greater the mass of phosphorus accumulated in the media. However, this factor has to be balanced with the hydraulic conductivity and the benefit of trapping the phosphorus in a solid matrix rather than as a wet sludge.

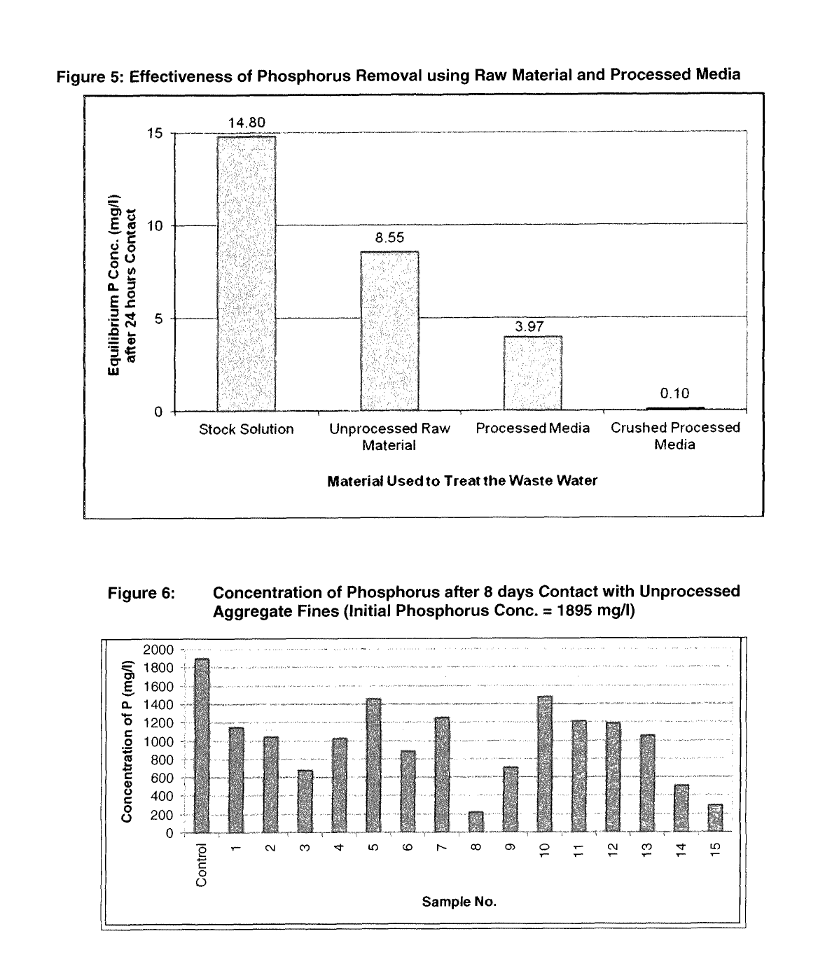

The unprocessed raw material has some capacity to remove phosphorus, but by applying the heat treatment processes described in this invention, the capacity to remove phosphorus is dramatically increased as shown in FIG. 5.

The capacity of the processed material to remove phosphorus depends on the initial characteristics of the waste fines and the selection of the most appropriate pelletising and heat processing methods. The theoretical ultimate capacity to remove phosphorus is likely to be in the region of 150-200 g P/kg of media and saturation tests have measured the media capacity up to 155 g P/kg media. This capacity is however dependant on the source material, processing temperature, influent concentration and contact time between the media and the effluent.

Advantageously, the present invention as summarised is a sustainable phosphorus removal system and utilises a waste by-product material generated as a result of mineral processing activity.

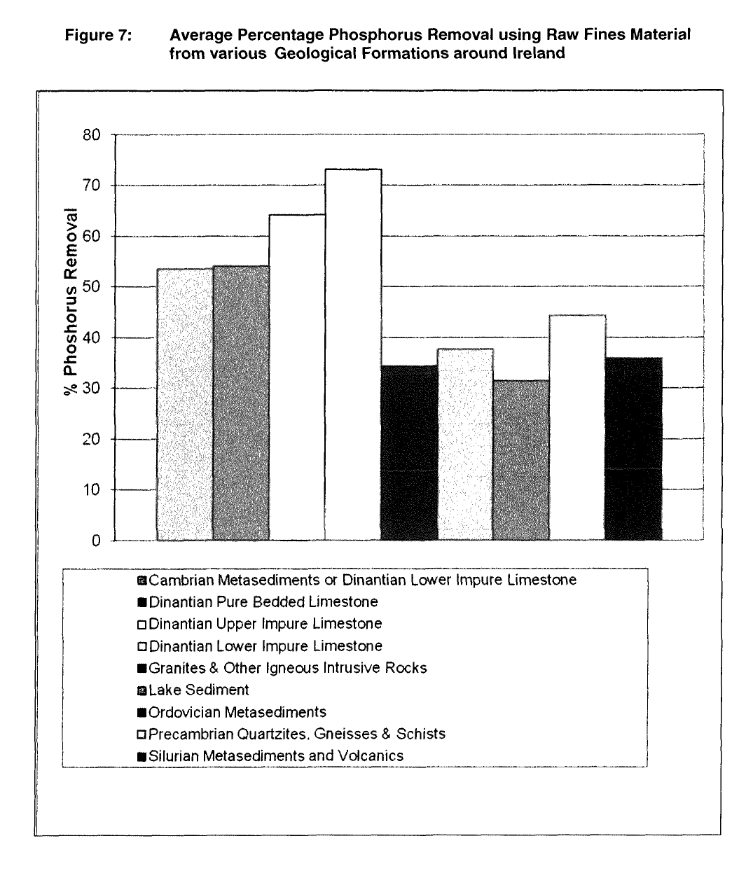

As shown in Example 1 below and FIGS. 6 and 7, the invention is effective using waste fines material from a range of source locations, widely dispersed geographically, with different bedrock types, and with different processing methodologies and grain sizes.

The primary use of the invention is the utilisation of the processed material to remove phosphorus from wastewater. However, the processed material may also be used for the following end uses:

Disinfectant in Wastewater Treatment
The high pH of the effluent and the typical retention times used to achieve high levels of phosphorus removal combine to generate a treated wastewater with significantly reduced pathogen content. In one full-scale system according to this invention treating effluent from a biological treatment system with only approximately 32 g of media per litre of wastewater, the total coliform count was reduced from 24,000 to 1100 MPN/100 ml. By increasing the ratio of media to wastewater, significantly greater removal of pathogens can be achieved.

Use of Processed Material to Remove Suspended Solids and Suspended Organic Matter
The processed material produced in accordance with this invention can be used to remove residual suspended solids and suspended organic matter from biologically treated effluents. Greater efficiency will be achieved with smaller processed material particle sizes but this has to be balanced with the hydraulic conductivity.

Use of Processed Material for Combined Removal of Phosphorus, Pathogens, Suspended Solids and Suspended Organic Matter
The processed material produced in accordance with this invention can be used to remove a range of contaminants in one process step—namely phosphorus, pathogens, suspended solids and suspended organic matter.

pH Correction
The processed material produced in accordance with this invention can be used as a replacement for lime or other alkaline substances to raise the pH of water and wastewater. One notable example is the treatment of Acid Mine Drainage (AMD). One of the main advantages would be the absence of the requirement to store and mix chemical powders such as lime or quicklime, which are very difficult processes to control on a site.

Removal of Heavy Metals and Other Contaminants
It is known that many contaminants can be removed from wastewater by raising the pH and the use of the processed material produced by this invention can achieve similar results without the problems associated with the use of lime or quicklime.

Table 3 below presents the analysis before and after use of the process treating a secondary (biologically treated) sewage at a full scale wastewater treatment plant.

TABLE 3
Efficiency of Process treating Biologically Treated Sewage

| | | | | % |
|---|---|---|---|---|
| Parameter | Units | Influent | Effluent | Removal |
| BOD (with nitrification | mg/l | <2 | <2 | — |
| inhibition) | | | | |
| COD | mg/l | 20 | <10 | >50% |
| Suspended Solids | mg/l | 5 | <2 | >60% |
| Total Nitrogen as N | mg/l | 8.135 | 6.489 | 20.2 |
| Orthophosphate as PO₄—P | mg/l | 1.275 | 0.426 | 66.6 |
| Total Phosphorus as P | mg/l | 1.46 | 0.5 | 65.8 |
| Total conforms (filtration) | cfu/100 ml | 23000 | 910 | 96.0 |
| E coli (filtration) | cfu/100 ml | 8200 | 200 | 97.6 |
| Clostridium Perfringens | cfu/100 ml | 98 | 4 | 95.9 |

### EXAMPLES

### Example 1

A series of tests was carried out to establish if the phosphorus removal capacity of aggregate processing fines is particular to an individual source or is consistent across a range of fines. To conduct these tests, a selection of fines was collected from across Ireland. The source locations were selected to give a wide variety of geographical locations and underlying bedrock type.

This test was designed to qualitatively establish if differing sources of fines all had phosphorus removal properties. The tests did not allow results to be directly compared against each other as the water content of the raw materials were not standardised across the range of samples and neither was the grain size of the material. However, the tests allow firm conclusions to be drawn on the potential of the invention to work, irrespective of the source of the raw material.

To establish if the different samples of fines had phosphorus removal properties, 100 g+/−5 g of each sample was added to 200 mls of a stock solution with a phosphorus concentration of 1895 mg/l. The samples were left for 8 days and agitated regularly to ensure good contact between the stock solution and the samples of fines.

After 8 days contact time, the samples were allowed to settle and the supernatant tested for phosphorus concentration. The reduction in phosphorus concentration between the supernatant and the initial stock solution was presumed to be the quantity of phosphorus removed by the raw fines. The results are presented in FIG. 6. They show that whilst there was significant variation between the different source materials, in all cases, contact between the stock solution and the aggregate processing fines resulted in a concentration reduction of phosphorus in the solution.

A number of the sites were located in similar geological formations and FIG. 7 presents the average percentage phosphorus removal for each geological formation sampled.

A number of these samples were pelletised and heat treated in accordance with the method outlined in this specification. It was found that in all cases, these pellets hardened. Although all source materials hardened during heat treatment, it was found that there was significant variation in the temperature required to produce a utilisable product. This would indicate that each individual source material requires prior investigation to establish the ideal temperature for processing prior to large scale production.

### Example 2

This test was designed to establish if processing improves the ability of the raw material to remove phosphorus. To provide extra detail, lime and powdered processed material were also tested in this example.

The different samples of phosphorus removal agents tested were:
1 Lime
2 Processed (pelletised) material, processed at 1150° C.
3 Powdered processed material—prepared by filing down pellets after processing at 1150° C.
4 Raw fines—this material was pre-dried at 250° C. for 1 hour to ensure 100% dry solid content and then crushed up to powder.

Each media type was added to 1 litre of 14.8 mg/l phosphorus stock solution. The media was added in small quantities, shaken and then allowed to settle. 30 minutes after the addition of the media, a phosphorus test was conducted to assess the removal capacity. After a total of 18 g of media was added, the samples were then left to settle for 24 hours. After this 24 hour period, the concentration of phosphorus in the stock solution was re-tested.

The phosphorus removal agents were added in the following sequence: 1 g, 2 g (3 g total), 5 g (8 g total), 10 g (18 g total), 0 g (18 g total with 24 hrs contact time).

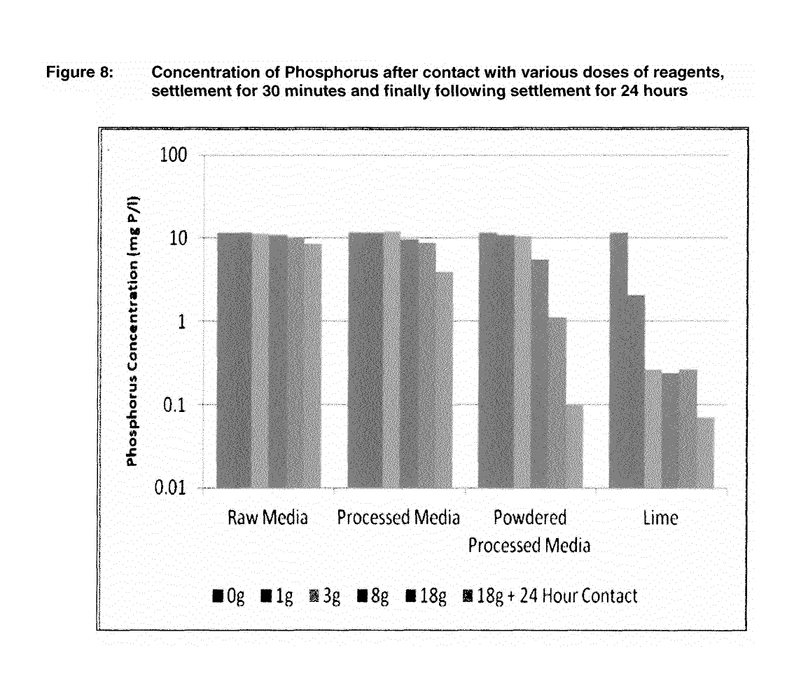

Each sample was tested in triplicate. The results of the analysis are presented in FIG. 8.

This test demonstrates that all four phosphorus removal agents were effective in lowering the influent concentration of phosphorus. The efficiency of these agents varied considerably, both in the quantity of agent required for efficient phosphorus reduction and the contact time necessary to achieve this reduction. However, it can be seen in FIG. 8 that processing as outlined in this specification resulted in significantly improved efficiency of treatment over that demonstrated by the raw material. This improvement in efficiency is seen in both the quantities required to facilitate phosphorus removal and in the contact time necessary for this removal to occur.

In addition, the test demonstrates that media processed into a fine powder can achieve results for phosphorus removal which are commensurate with that obtained using lime. The results using media pellets and raw fines were less efficient than using lime when the test conditions outlined above are followed. However, this test also demonstrates the advantage of using the media produced in accordance with this invention. Where lime is used to remove phosphorus, the phosphorus is contained in a wet (liquid) sludge which is continuously generated and must be separated, stored, thickened, dewatered and disposed of, and this has considerable cost and operational implications. In the case of the application of this invention, the phosphorus is contained in the solid matrix of the media. This has an enormous advantage in full scale plants because it obviates the need to store, mix (and keep mixed) and dose lime which presents considerable difficulty from a cost, health and safety and operational perspective. The media produced and operated in accordance with this invention can sorb very high quantities of phosphorus relative to its mass and volume compared to other media used for this purpose as will be demonstrated in other examples below.

### Example 3

Laboratory testing was conducted to establish the effect of influent phosphorus concentration on the ability of the manufactured media to remove phosphorus from an effluent stream. To conduct this test, a range of differing concentration stock solutions were pumped through columns of media and the phosphorus concentration of the effluent after treatment was measured.

To conduct this test, apparatus was constructed which comprised of 1.5 m lengths of 50 mm diameter plastic tubing. Each of these tubes was filled with 1.2 litres of media. Different concentrations of phosphorus stock solutions were pumped in to the base of each tube with the effluent collected at the top, thus replicating a typical full-scale wastewater treatment plant. Eight different concentrations of phosphorus stock were selected for treatment; 5, 10, 100, 500, 1000, 6500, 10875, 21500 and 38625 mg/l. The pumps were set to a flow rate of approx 1.2 litres per day or 1 day's retention time. In reality, the average flow rate throughout the duration of the test varied from 1.05 to 1.15 litres per day. The test was run for a period of approximately 40 days, although not all concentrations of stock were analysed for this entire duration.

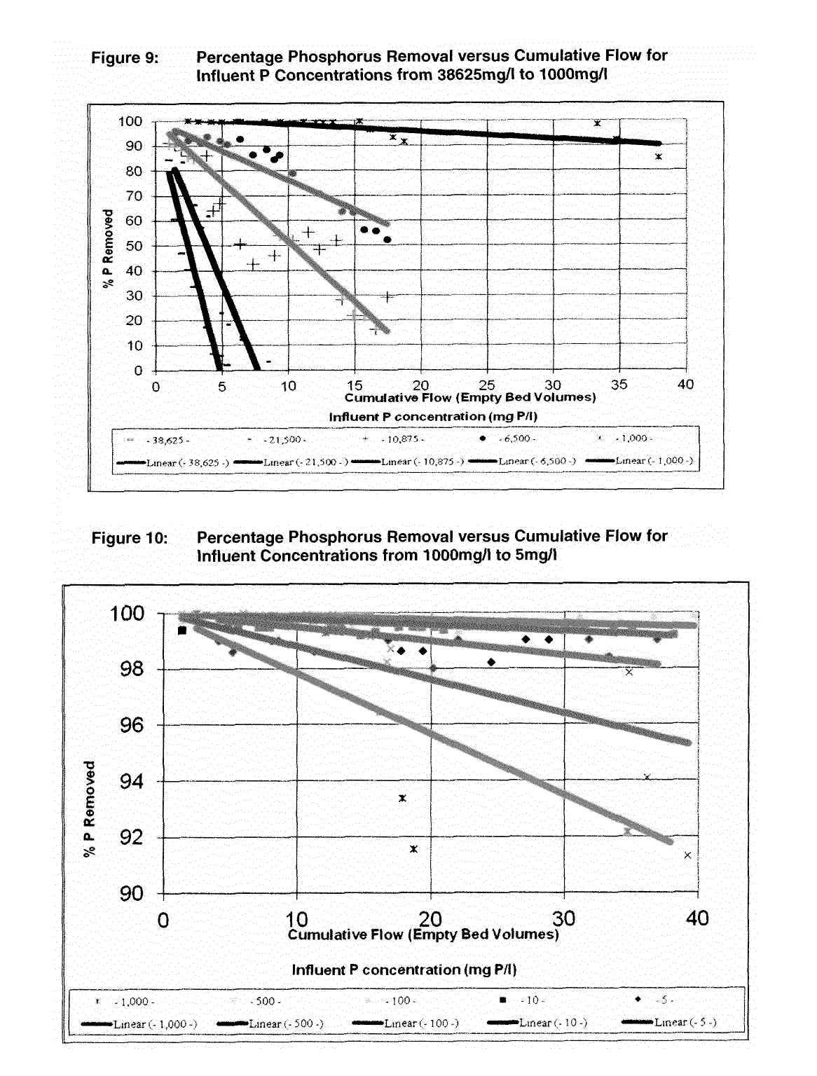

The results of this analysis are presented in FIGS. 9-12.

These tests confirmed that the invention as detailed in this specification has the capacity to remove phosphorus from influents with a vast range of phosphorus concentrations, from the very low strength (5 mg/l) to the very high strength (38,625 mg/l).

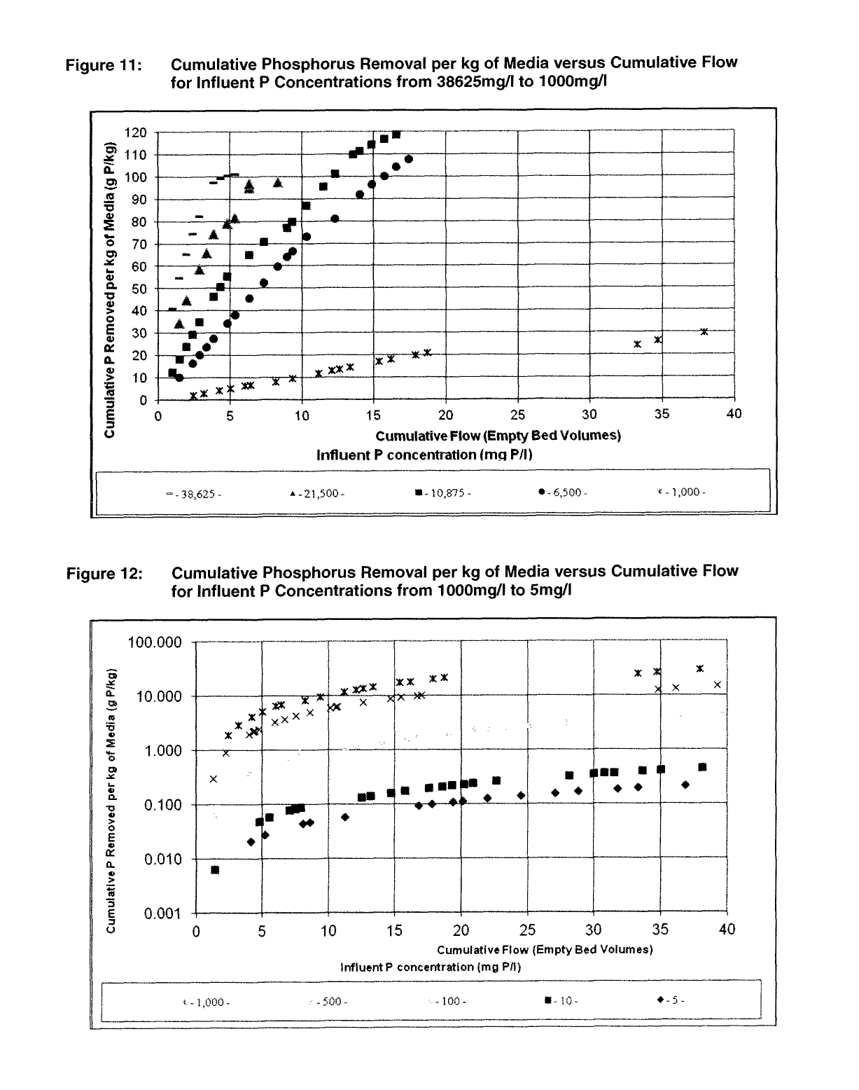

FIG. 11 shows that the media manufactured in accordance with this invention retained in the region of 100 to 120 g P/kg of media when wastewater with high concentrations of phosphorus is treated. It should be noted that there was still a substantial additional binding capacity remaining in the columns treating the 6,500 and 10,875 mg P/I.

FIG. 12 shows that when treating wastewater with relatively low concentrations of phosphorus, only a fraction of the ultimate phosphorus binding capacity of the media was used with the number of bed volumes treated.

### Example 4

This test was designed to assess the ability of the media to remove phosphorus from an effluent over an extended period of time. The test was designed to mimic conditions and phosphorus concentrations that would be expected at a wastewater treatment plant.

A laboratory scale pilot plant was constructed consisting of two 100 mm diameter pipes with a bottom inlet and top outlet. Each pipe was filled with 4 litres of media, one having been heat treated to 1100° C. and the other heat treated to 1200° C. A variable speed peristaltic pump was used to dose the media from the base of the apparatus with a phosphorus stock solution that had an approximate concentration of 10 mg/l, although this concentration varied between 8 and 14 mg/l throughout the test period. The treated effluent was discharged from the top of the apparatus via the outlet and was collected in a container as a composite sample. This composite sample was then tested to monitor the concentration of phosphorus remaining in the wastewater.

Prior to the media being inserted into the apparatus, a void space calculation was conducted on the media. This test showed that the approximate void space was 1600 mls in 4 litres of media, or approximately 40% of the total bed volume.

This test was designed to assess the efficiency of the media over an extended period of time. The test also assessed the phosphorus removal capability of the media over a variety of flow rate conditions and therefore, retention times. This test was not designed to optimise the process.

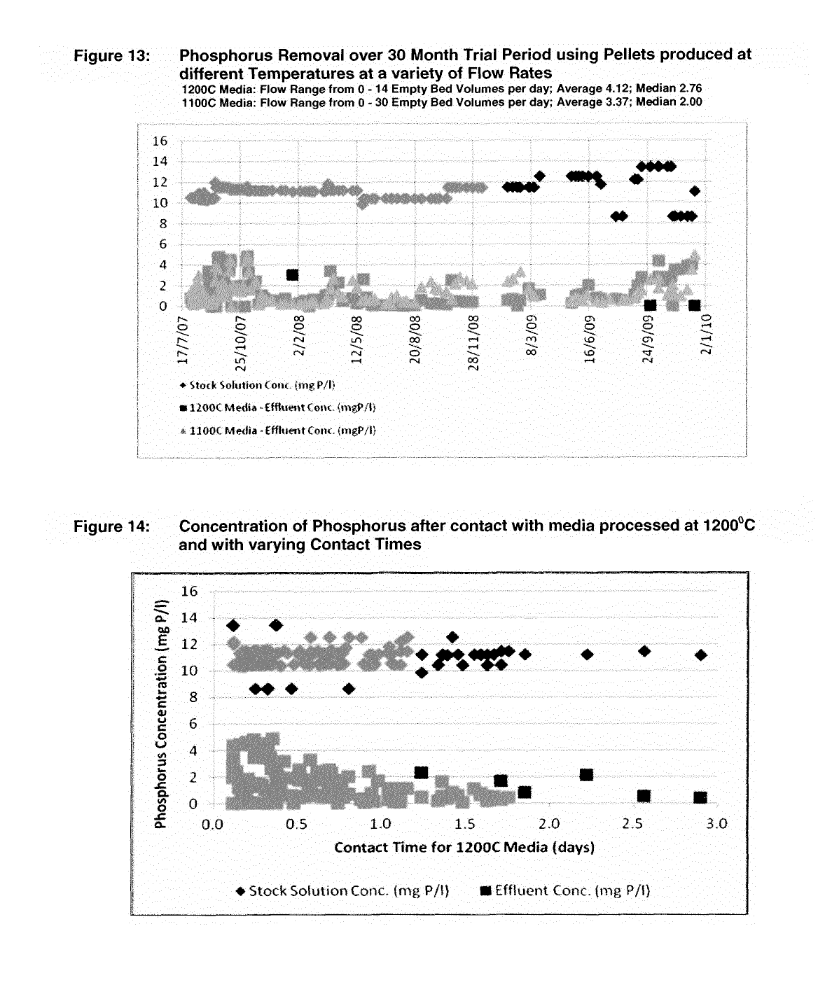

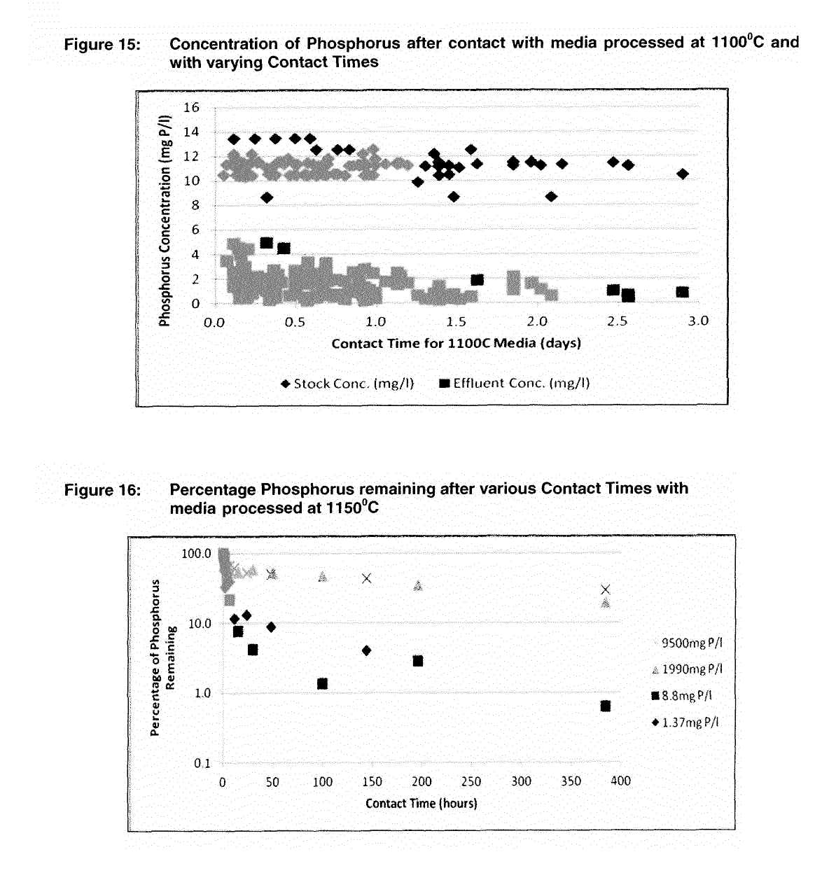

FIGS. 13-15 clearly demonstrate the ability of the media to continue to remove phosphorus over the duration of the test (30 months).

### Example 5

This test was designed to establish the rate of reaction in removal of phosphorus.

The test involved the addition of 100 g of media pellets processed at 1150° C. to 500 mls of varying strength stock solutions; 1 mg/l, 10 mg/l, 2,000 mg/l and 10,000 mg/l in a laboratory pot test. The phosphorus concentration of the solution was monitored at regular time intervals, and the results are presented in FIG. 16.

The results of this analysis showed that when media pellets are exposed to liquid containing phosphorus, removal of phosphorus commences immediately with the fastest rate of reaction during the first 24 hours of contact. As contact time increases, the rate of phosphorus removal decreases.

### Example 6

This test was designed to establish the ultimate capacity of the media or the point at which the media is no longer able to remove further phosphorus when exposed to a fresh stock solution. To conduct this test, very high strength phosphorus stock solution was treated in a batch process by exposure to media until the media no longer removed significant quantities of phosphorus from the solution. Very high strength stock was used as previous tests using 2,000 mg/l P solution and 10,000 mg/l P solution failed to reach an end point where the media could no longer remove phosphorus from the influent stock solution.

In this test, 100 g of media was added to 200 mls of stock solution with a phosphorus concentration of 52,800 mg/l. Contact between the stock solution and the media was maintained until the rate of removal slowed significantly. The stock solution was then poured off, filtered and analysed for remaining phosphorus. The media was retained, added to fresh stock solution and again left for sufficient time to allow any phosphorus removal reactions to continue to completion. This test was repeated until the concentration of phosphorus in fresh stock was not reduced after exposure to the media.

TABLE 4
Ultimate Capacity of the Media to Retain Phosphorus

| | Initial | Final | P removed | Mass of P | Mass of P |
|---|---|---|---|---|---|
| | Phosphorus | Phosphorus | from | removed from | removed per |
| | Concentration | Concentration | solution | 0.2 l of | g of media |
| | (mg/l) | (mg/l) | (mg P/l) | solution (mgP) | (mg P/g) |
| Stock Solution | 52,800 | — | — | — | — |
| Initial Dosing | 52,800 | 17,200 | 35,600 | 7,120 | 71.2 |
| 1^{st} Repeat Dosing | 52,800 | 31,600 | 21,200 | 4,240 | 42.4 |
| 2^{nd} Repeat Dosing | 52,800 | 32,000 | 20,800 | 4,160 | 41.6 |
| 3^{rd} Repeat Dosing | 52,800 | 52,800 | 0 | 0 | 0 |
| Total P removal | | — | — | 15,520 | 155.2 |

### Example 7

To further assess the heat treatment process as described in this specification, a test was conducted using 3 different firing techniques.
1. Continuous—rotary kiln—processing media at 1150²C for 7 minutes in the hot zone using oil as heat source
2. Batch—small top loading kiln (total capacity 12L) using electricity as heat source
3. Batch—front loading kiln (total capacity 120L) using gas as heat source

These samples were tested for their ability to remove phosphorus from wastewater in a batch process, whereby 200 mls of approximately 2,000 mg P/I stock solution was added to 100 g of each media type. The media was left in contact with the solution for 7 days to ensure maximum removal.

TABLE 5
Effect of Method of Production on Phosphorus Removal Capability

| | Initial | Final | | P Retained by |
|---|---|---|---|---|
| | Phosphorus | Phosphorus | | Media after |
| | Concentration | Concentration | | treating 0.2 L |
| Method Used to | in Wastewater | in Wastewater | % P | of Wastewater |
| Produce the Media | (mg/l) | (mg/l) | Removed | (mg P/g media) |
| Rotary Kiln - Oil | 1920 | 0.09 | 99.99% | 3.84 |
| Small Capacity Kiln -- | 1920 | 260 | 86.46% | 3.32 |
| Electricity | | | | |
| Medium Capacity Kiln - | 1920 | 0.46 | 99.98% | 3.84 |
| Gas | | | | |

Both the samples from the medium capacity kiln and the rotary kiln produced results in excess of that previously seen in other tests and were able to remove 99.98% and 99.99% respectively from the available phosphorus in this high strength effluent.

The reduced removal efficiency exhibited by the media processed using the small batch kiln is presumed to relate to the fact that this kiln was essentially “closed” whereas the other two larger kilns were open to the atmosphere, thereby allowing a more oxygenated firing process in the larger kilns.

The results of 3.32-3.84 mg P removed per g media are not representative of the ultimate sorption capacity of the media as the phosphorus concentration of the stock solution was not high enough, almost all of the phosphorus was removed in two of the tests and as previous tests have shown, adding fresh stock solution to the media results in on-going additional P removal.

While the mineral fines for producing the wastewater treatment pellets may conveniently be derived from silt washings from sand and gravel it may also be derived from other sources (e.g. calcium from crushed limestone rock mixed with other sources of aluminium, iron, etc.) not directed relates to sand and gravel production.

The invention is not limited to the embodiments hereinbefore described which may be varied in construction and detail within the scope of the appended claims.

1. A method for manufacturing wastewater treatment pellets comprising the steps of pelletising mineral fines having a particle size of less than 0.063 mm and firing the pellets for forming porous wastewater treatment pellets.

2. The method of claim 1 further comprising the step of drying the mineral fines to a moisture content in the range of 10% to 20% before pelletising.

3. (canceled)

4. The method of claim 1, further comprising forming the pellets by means of a rolling process.

5. The method of claim 1 further comprising forming the pellets with a diameter of 0.5 mm to 30 mm.

6. (canceled)

7. The method as claimed in claim 1, further comprising firing the pellets at a temperature in the range 600° C. to 1200° C.

8-10. (canceled)

11. The method of claim 1, wherein the ceramic material has the following physical and chemical properties

| Parameter | Typical Value | |
|---|---|---|
| Average Particle Size | 0.5-30 | mm |
| Loose Bulk Density | 700-1200 | Mg/m³ |
| Hydraulic Conductivity | 3-5 × 10⁻² | m/s |
| Water Absorption | 30-50% | by weight |
| SiO₂ | 20-60% | by weight |
| CaO | 25-75% | by weight |
| Al₂O₃ | 1-20% | by weight |
| Fe₂O₃ | 1-20% | by weight |

12. A wastewater treatment process for recovering phosphorus from wastewater comprising the step of bringing the wastewater into contact with wastewater treatment pellets produced by the method of pelletising mineral fines having a particle size of less than 0.063 mm and firing the pellets.

13. The wastewater treatment process as claimed in claim 12 wherein the process further comprises passing the wastewater through a container having a wastewater inlet and a wastewater outlet and a plurality of wastewater treatment pellets mounted between the wastewater inlet and the wastewater outlet.

14. The wastewater treatment process as claimed in claim 12 wherein the process further comprises holding the wastewater treatment pellets in suspension in the wastewater.

15. The wastewater treatment process as claimed in claim 12 further comprising controlling the flow of the wastewater to maintain the wastewater in contact with the wastewater treatment pellets for a desired time period.

16. The wastewater treatment process as claimed in claim 13 wherein the wastewater treatment pellets are mounted in one or more cartridges which are demountably secured within the container.

17. The wastewater treatment process as claimed in claim 16 wherein the cartridge has a water impermeable wall with a water inlet and a water outlet to direct wastewater flow through the wastewater treatment pellets within the cartridge.

18. The wastewater treatment process as claimed in claim 16 wherein the cartridge has a perforated side wall to allow through-passage of the wastewater.

19. The wastewater treatment process as claimed in claim 13, wherein a portion of the treated wastewater is recycled from the wastewater outlet of the container back to the wastewater inlet of the container.

20. The wastewater treatment process as claimed in claim 12, wherein the process further comprises, after treatment of the wastewater by the wastewater treatment pellets, the step of passing the treated wastewater through a soil polishing filter, or other passive medium to reduce the pH of the treated wastewater to less than 9.

21. The wastewater treatment process as claimed in claim 12, wherein the process further comprises, after treatment of the wastewater by the wastewater treatment pellets, the step of reacting the treated wastewater with carbon dioxide to reduce the pH to less than 9.

22. The wastewater treatment process as claimed in claim 12, wherein the process further comprises, after treatment of the wastewater with the wastewater treatment pellets, the step of dosing the treated wastewater with an acid to reduce the pH to less than 9.

23. The process as claimed in claim 12, wherein the process further comprises the step of recovering the phosphorus captured by the wastewater treatment pellets during the process.

24. A method for the combined removal of one or more of phosphorus, suspended solids, suspended organic matter, ammonia and pathogens from water comprising the use of the pellets produced by the method of pelletising mineral fines having a particle size of less than 0.063 mm and firing the pellets.

25-29. (canceled)
